(19) United States
(12) Patent Application Publication
(10) Pub. No.: US 2007/0019957 A1
(43) Pub. Date: Jan. 25, 2007

(54) Dynamic bandwidth allocation apparatus and method in Ethernet Passive Optical Network, and EPON master apparatus using the same

(76) Inventors: Chan Kim, Daejeon (KR); Tae Whan Yoo, Daejeon (KR); Yool Kwon, Busan (KR); Bong-Tae Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/488,868

(22) Filed: Jul. 18, 2006

(30) Foreign Application Priority Data
Jul. 19, 2005 (KR) 10-2005-0065230
Dec. 9, 2005 (KR) 10-2005-00120651

(51) Int. Cl. H04J 14/00

(52) U.S. Cl. 398/72

(57) ABSTRACT

The invention provides a method and apparatus for allocating a dynamic band width of an EPON and an EPON master apparatus using the same. The bandwidth allocation is cycle based where every predetermined cycle, static gates are generated for all ONUs and dynamic gates are generated according to the reports using the remaining grant resource. The method for allocating an upstream bandwidth to transmit data from the ONUs to an OLT is as follows. A total allocatable grant length is calculated for the given cycle. A requested amount of grant length needed to transmit upstream data in each ONU is set based on report values collected from the report frames from all ONUs in the EPON. Then, distribution is made sequentially and repeatedly in a cycle by taking a basic unit from the total grant length and adding it to the grant length of the ONUs until the total allocatable grant length becomes 0 or the grant length allocated to all ONUs satisfy the requested amount of the grant length set in all ONUs.

### CLAIM OF PRIORITY

This application claims the benefit of Korean Patent Application No. 2005-0065230 filed on Jul. 19, 2005, and Korean Patent Application No. 2005-120651 filed on Dec. 9, 2005, in the Korean Intellectual Property Office, the disclosure of which is incorporated herein by reference.

### BACKGROUND OF THE INVENTION

1. Field of the Invention

The present invention relates to a method and apparatus for allocating a dynamic bandwidth of an Ethernet Passive Optical Network (EPON) by which an Optical Line Termination (OLT) of the EPON allocates an upstream bandwidth for data transmission to a plurality of Optical Network Units (ONUs), and an EPON master apparatus using the same.

2. Description of the Related Art

The advancement in subscriber network has led to the EPON which allows communication through use of Ethernet frame in a Passive Optical Network (PON), and the standardization via IEEE802 group.

The EPON, as shown in FIG. 1, features a passive connection between the OLT 110 coupled to a network side and a plurality of Optical Network Units (ONU) 120a-120c coupled to a subscriber side through an optical splitter 130. Within the EPON, unlike Asynchronous Transfer Mode (ATM)-PON, data is transferred by a unit equal to that of the existing Ethernet frame. To achieve compatibility with the upper layer bridge, a Logical Link Identification (LLID) for identifying the ONUs 120a-120c is attached at the 8 byte preamble of Ethernet frame, which is attached when transmitted.

LLID of Ethernet frame transferred from the OLT 110 to the ONUs 120a-120c (hereinafter referred to as a downstream frame) signifies to which ONU the transfer is to be made, whereas LLID of Ethernet frame transferred from the ONUs 120a-120c to the OLT 110 (hereinafter referred to as an upstream frame) signifies by which ONU the transfer has been made. The upstream frame and downstream frame are transmitted through different wavelengths.

When the downstream frame is sent to all ONUs 120a-120c, each ONU 120a-120c identifies LLID of the downstream frame, and selectively receives the downstream frame, which is headed for the ONU. LLID of the downstream frame can specify the receiver to be all ONUs, all ONUs except for a specific ONU, or a specific multicast ONU group.

Meanwhile, the upstream frame of each ONU 120a-120c is sent to the OLT 110. To prevent signal overlapping between the upstream frames of the ONUs 120a-120c, the OLT 110 arbitrates upstream transmission times of the ONUs 120a-120c while allocating transmission grant time to be used in each ONU 120a-120c, which is called bandwidth allocation.

For the above-identified process, the ONUs 120a-120c notify the OLT 110 of transmission queue status thereof, or data amount to be transmitted via a report frame. Correspondingly, the OLT 110 sends a gate frame to the ONUs 120a-120c and notifies transmission start time and permitted transmission duration. The ONUs 120a-120c, which have received the gate frame, keep and monitor the transmission start time and permitted transmission duration, and send an upstream frame to the OLT 110 during the designated time period. Transmission permission information recorded in the gate frame is called the grant, which is indicated with transmission start time and length. Report frame, gate frame and ONU's automatic registration are processed via Mutlti-Point Control Protocol (MPCP).

Allocating an upstream bandwidth to each ONU 120a-120c means setting a grant value at the gate frame in the form of transmission start time and length, and transmitting the same to the ONU.

Transmission start time and length of the grant are determined by the OLT 110. Latency of optical fiber transfer and other latencies for the ONUs 120a-120c having different geological distances should be taken into consideration to prevent upstream frame from arriving at the OLT 110 at the overlapping moments. Furthermore, the grant should not be excessively allocated to only a specified ONU to delay upstream frames of other ONUs and should prevent unnecessary wasting of resources. In addition, the grant allocation should vary depending on conditions since transmission data amount generated by the ONUs cannot be always the same, which is called dynamic bandwidth allocation.

### SUMMARY OF THE INVENTION

The present invention has been made to solve the aforementioned problems and it is therefore an object of the present invention to provide a method and apparatus for allocating an Ethernet Passive Optical Network (EPON) dynamic bandwidth, capable of efficiently allocating a grant to a plurality of ONUs to ensure a stable and effective EPON communication, and an EPON master apparatus using the same.

It is another objective of the invention to provide a method and apparatus for allocating the EPON dynamic bandwidth to distribute the grant properly based on the transmission data amount of the ONUs while guaranteeing minimum transmission time for the ONUs without a complex floating point algorithm, and an EPON master apparatus using the same.

It is further another objective of the invention to provide a method and apparatus in EPON for dynamically allocating the dynamic bandwidth which ensure a priority-based differential service by distributing bandwidth first to a high-priority data and then to a low-priority data in view of priorities of requests by each ONU.

According to an aspect of the present invention, there is provided a method for allocating an EPON dynamic bandwidth to allocate an upstream bandwidth by which data is transmitted from a plurality of the ONUs to the OLT, the method comprising steps of:

(a) calculating a total allocatable grant length in a predetermined cycle;

(b) setting a requested amount of grant length needed for each of the ONUs in the EPON to transmit upstream data based on report frames received from all ONUs;

(c) taking a basic unit from the total grant length and adding it to each ONU sequentially and repeatedly until the total remaining grant length becomes 0 or for all ONUs the allocated grant length reaches the requested amount of grant length set for each ONU; and

(d) setting the allocated grant length of each ONU at the stage as grant length of the ONU if the total remaining allocatable grant length becomes 0 or for all ONUs the allocated grant length reaches the requested amount of grant length set for each ONU.

According to another aspect of the present invention, there is provided an apparatus for allocating a dynamic bandwidth in an EPON by which a plurality of ONUs send data to Optical Line Termination (OLT), comprising: a report reader which is initiated by a start signal coming periodically with a predetermined cycle and sets a required grant amount for each ONU by reading report values that have been received and stored in a table up to that moment ; at least one bandwidth-allocating engine in charge of ONU groups, the engine being adapted to receive a required grant amount of the ONU in its group from the report reader, take a basic unit from the total usable grant length and additively allocate it each ONU in a sequential and repeated manner so that the grant length of the ONU reaches the required grant amount; and a controller adapted to collect operation status of the report reader and a plurality of the bandwidth-allocating engine, control the starting and stopping of the engines, and notify the engines of the total remaining grant length and combined status of the satisfaction of the required grant amount of all ONUs.

According to further another aspect of the present invention, there is provided an Ethernet Passive Optical Network (EPON) master apparatus for processing Multi-point Control Protocol (MPCP) for data communication of an EPON including an OLT and a plurality of Optical Network Units (ONUs), comprising: a report table storing report data sent from each ONU; a dynamic grant generator adapted to set a required grant amount of each ONU based on report data of each ONU in the report table for each grant allocation cycle, taking and additively allocating a basic unit from a total usable grant length to each ONU repeatedly, and if the total usable grant length becomes 0 or the grant length allocated to all ONUs reaches the required grant amount, set the dynamic grant value based on the distributed amount to each ONU at the time point; a dynamic grant queue storing the dynamic grant value generated by the dynamic grant generator; a transmit multiplexer adapted to multiplex downstream transmission data coming from the upper network port and the gate frames read in from the dynamic grant queue; a receiving demultiplexer adapted to demultiplex a received upstream frames to each destination, report frames out of the received frames being transferred to a report writer; a report writer adapted to update the report data of each ONU in the report table in accordance with the report frame transferred from the receiving demultiplexer; and a start time calculator adapted to determine grant start time to be at future by a predetermined value from the present time and insert the start time to the gate frame out of downstream data transmitted from the transmit multiplexer while ensuring adjacent grant window specified by the start time and the length not to overlap with each other.

### BRIEF DESCRIPTION OF THE DRAWINGS

The above and other features and advantages of the present invention will become more apparent by describing in detail exemplary embodiments thereof with respect to the attached drawings in which:

FIG. 1 is a view illustrating the configuration of a general Ethernet Passive Optical Network (EPON);

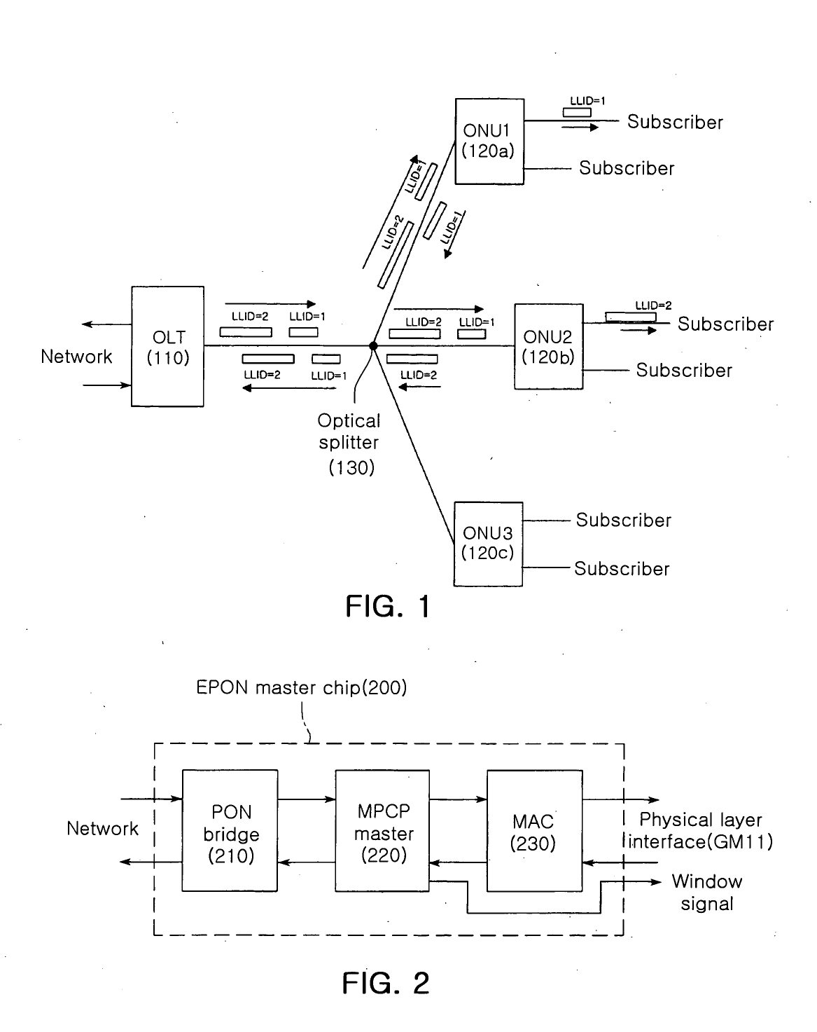

FIG. 2 is a basic view of an EPON master chip;

FIG. 3 is a block diagram showing the overall configuration of an EPON master employing an apparatus for allocating a dynamic bandwidth of the invention;

FIG. 4 is a block diagram showing the configuration of the apparatus for allocating a dynamic bandwidth of the invention;

FIG. 5 is a flow chart of a method for allocating a dynamic bandwidth of the invention;

FIG. 6 is a flow chart showing a process of setting a requested amount for each ONU according to a first embodiment of the invention;

FIG. 7 is a flow chart showing a process of setting a requested amount for each ONU according to a second embodiment of the invention;

FIG. 8a is a view showing adjustment of a requested amount for each ONU to be within a maximum limit according to a second embodiment of the invention;

FIG. 8b is a view showing an example of setting the minimum guarantee amount, the effective high-priority requested amount and the effective low-priority requested amount according to the second embodiment of the invention;

FIG. 9 is a detailed flow chart showing the dynamic bandwidth allocation method of the invention; and

FIGS. 10a and 10b are detailed flow charts showing the process of dynamic bandwidth allocation according to the second embodiment of the invention.

### DETAILED DESCRIPTION OF THE PREFERRED EMBODIMENT

Hereinafter, embodiments of the present invention will be described in detail with reference to the appended drawings.

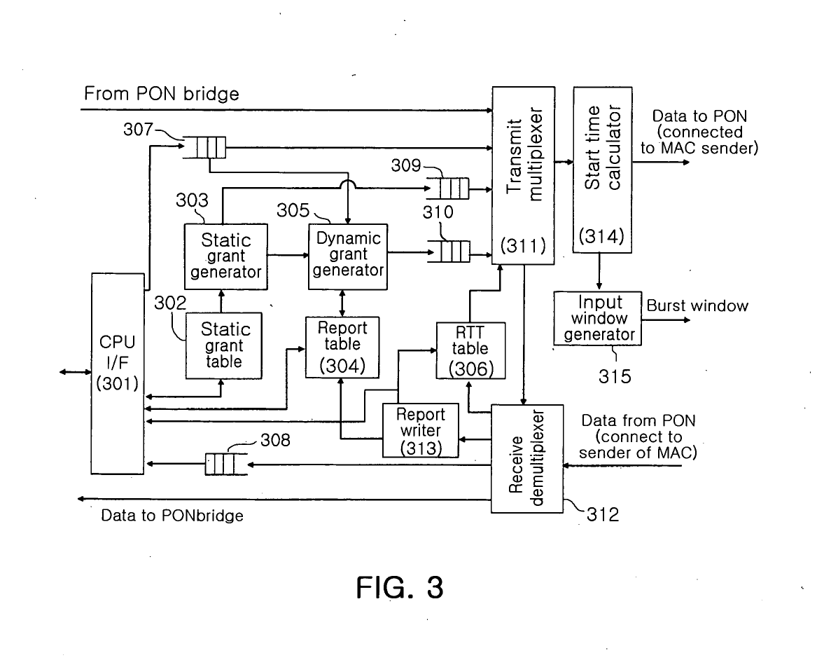

FIG. 2 is a view illustrating the configuration of an EPON master chip to which the invention is applied.

The EPON master chip is installed in an OLT 110 of the EPON and serves as a means to process MPCP in the EPON communication such as multiplexing and demultiplexing an upstream and downstream Ethernet frame to transmit to a destination, while carrying out grant scheduling for each LLID and registration of a new ONU. The EPON master chip includes a PON bridge 210 connected with the upper network process interface and adapted to process Ethernet frame switching between the upper network port and many lower PON logical ports differentiated by LLIDs providing compatibility to the upper network, an MPCP master 220 adapted to process frame multiplexing and demultiplexing while processing MPCP data and perform grant scheduling and auto-discovery for each LLID, and a MAC 230 connected to the physical layer interface (communication channel) and adapted to send and receive frame to/from the physical layer including generation and inspection of a Frame Check Sequence (FCS) for all the frames.

More particularly, the PON bridge 210, when provided with an upstream frame from the MPCP master 220, examines the destination address (DA) of the frame and judges whether the upstream frame is to be transferred to the network side or to the EPON subscriber side with different LLID. If judged to be transferred to the network port, the upstream frame is transferred after the deletion of LLID, whereas in case of its transfer to a certain ONU, the upstream frame is transferred back to the MPCP master 220 with a corresponding LLID replaced thereto. Conversely, the PON bridge 210, if provided with a downstream Ethernet frame by the network port, examines the DA value of the Ethernet frame. If directed toward a specific ONU, the frame is then transferred to the MPCP master with the LLID of the destination ONU. If the destination believed to be in the network port, the frame is discarded. The upstream frame is deleted upon judgment that it has been transferred to a corresponding MAC address via the network processor.

The MPCP master 220 exchanges LLID-attached Ethernet frames between the PON bridge 210 and MAC 230 to process MPCP under the control of a CPU of OLT, which is not illustrated. In other words, the MPCP master multiplexes a downstream Ethernet frame from the PON bridge 210 and a downstream Ethernet frame generated within the MPCP master and frames from the CPU (not illustrated) to transfer to the MAC 230, and receives an upstream Ethernet frame outputted from the MAC 230 to execute processing according to the frame type, and in the case of general data, it is transferred to the PON bridge 210.

The MAC 230 calculates Cyclic Redundancy Check (CRC) for the Ethernet frame received from the MPCP master 220 and inserts the calculation results into the Ethernet frame for transmission. The received Ethernet frame is transferred to the MPCP master 220 if the CRC test finds no errors.

The invention relates to the above-identified EPON master chip 200, more particularly a technique for allocating the grant for each ONU which is identified by LLID, which is applied to the MPCP master of the EPON master chip 200.

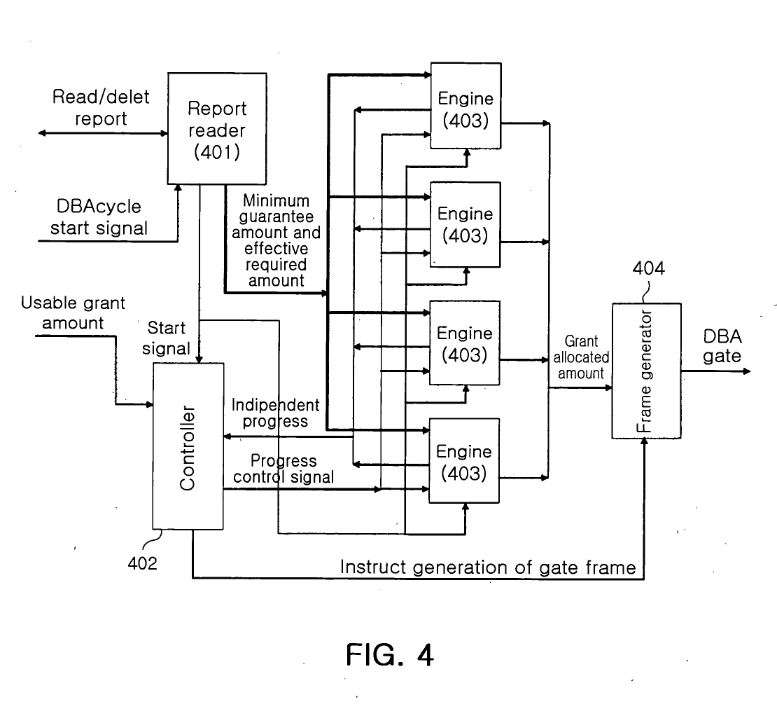

FIG. 3 is a detailed configuration view of an MPCP master apparatus employing an apparatus for allocating bandwidth according to the invention.

As shown in FIG. 3, the MPCP apparatus includes a CPU interface 301, a static grant table 302, a static grant generator 303, a report table 304, a dynamic grant generator 305, an RTT table 306, a transmit CPU message queue 307, a receive CPU message queue 308, a static gate queue 309, a dynamic gate queue 309, a transmit multiplexer 311, a receive demultiplexer 312, a report writer 313, a start time calculator 314, and an input window generator 315.

The CPU interface 301 interfaces to allow an outside CPU to read and write a variety of registers and through it CPU can insert and extract a frame, and read and write an inside table.

The static grant table 302 has information necessary to generate a fixed-length grant for each ONU, and it is set by an outside CPU and used by the static grant generator 303.

The static grant generator 303 every cycle reads information on the allocated static grant length of each ONU (LLID) from the static grant table 302, and based on which it allocates a fixed-length grant amount to each registered ONU. In this case, transmission start time of the grant values is not set but only a grant length value is determined. Normally, the static grant generator 303 is used to send gate frames with a short-length grant for each ONU before allocating a dynamic bandwidth every grant allocation cycle so that it can receive at least one report frame per grant allocation cycle.

Further, the static grant generator 303 subtracts the static grant amount allocated to all ONUs and a grant amount generated by the CPU which is in the transmission CPU message queue 307 from the total usable grant amount, notifies the dynamic generator 305 of the remaining usable grant amount for the corresponding cycle, which is produced by the calculation, and instructs the dynamic generator to generate dynamic grants.

The report table 304 records report data sent from each ONU, which is then read by the dynamic grant generator 305. For a stable bandwidth allocation, the report which has been used once is deleted and not allowed to be re-used. Also, according to this invention, regardless of traffic, a report is provided from the ONU to the OLT at least once in a cycle time and the report table 304 stores the latest reports to prevent a report latency or omission from deteriorating performance thereof.

The dynamic grant generator 305, after the static grant generation completes, simultaneously distributes the remaining usable grant amount input from the static grant generator 303 to each ONU (LLID) based on the reports recorded in the report table 304, and generates gate frames containing dynamic grant length.

More specifically, the dynamic grant generator 305 collects reports from each ONU every cycle to distribute a dynamic grant length to the registered ONUs 120a-120c based on the collected reports. The dynamic grant generator adopts so-called water-filling method in distributing grants: the ONUs are separated into several groups for parallel processing and in each group, and until the grant reaches a requested amount in the ONU (or LLID) or the total allocatable grant amount becomes 0, a predetermined unit of grant length is taken from the allocatable grant amount and allocated sequentially and cyclically to the ONUs in parallel for the groups. The grant amounts of the ONUs are filled sequentially but the grant length filling is expedited through parallel processing. Further, an allocatable amount is determined before distributing the grant resources so as to allocate within the limit and thereby excessive allocation of grants is prevented from the beginning. In addition, fairness is ensured due to sequential and equitable allocation by a basic unit to all the ONUs. Moreover, before distributing, the maximum length is restricted for each ONU to place a limit on the maximum upstream bandwidth for the ONU, while in distributing in practice, the minimum guarantee bandwidth is satisfied first and it is guaranteed for each ONU.

In fact, the start time of grant should always indicate a future time by as much as the sum of the maximum RTT value and the minimum waiting time in the ONU (hereinafter the sum is referred to as the minimum offset) because RTT is subtracted from the start time when the gate frame is transmitted and the ONU should see the grant start time as being away in the future by the minimum waiting time for processing margin. Thus, when a gate frame is sent continually, if it takes long to calculate the grants of the following gate frame, the minimum offset between two adjacent grants cannot be satisfied. As a result, the grant of the following gate frame cannot be positioned right after the grant designated by the previous gate frame and gap should be inserted in between, causing unused upstream bandwidth and accordingly decreasing communication efficiency.

To minimize this phenomenon, allocation of the grant should be carried out as quickly as possible. In a dynamic grant generator 305 of the invention, the plurality of grants are calculated simultaneously in parallel, allowing grant allocation to the plurality of ONUs in a short time. Therefore the minimum offset between the grant lengths allocated to each ONU can be satisfied when generating dynamic gate frames after the static gate generation and waiting of upstream bandwidth usage can be minimumized.

This grant allocation in the dynamic grant generator 305 is made in accordance with a method for allocating a dynamic bandwidth of the invention, and their method and construction will be explained in more detail hereunder.

The RTT table 306 shown in FIG. 3 stores the latest RTT value for the ONU (LLID) newly calculated upon receiving MPCP frame.

The sending CPU message queue 307 stores a CPU frame to send, which is transferred from a CPU, until being transmitted. The receiving CPU message queue 308 stores a received CPU frame, which is to be sent to the CPU until being read by the CPU. The sending CPU message queue 307, if there is any grant frame among the frames stored inside, notifies the dynamic grant generator 305 of the sum of the grant value.

The static grant queue 309 stores a static grant value generated in the static grant generator 303 and a dynamic grant queue 310 stores a dynamic grant value generated in the dynamic grant generator 305, which are transmitted via the transmit multiplexer 311.

The transmit multiplexer 311 receives the transmit requests from the sending CPU message queue 307, the fixed grant queue 307 and the dynamic grant queue 310 and a PON bridge 210, reads and multiplexes the selected frame data and transfers the same to the start time calculator 314. In a method for allocating bandwidth according to the invention, when there are more than one transmit requests, the transmit multiplexer 311 first reads gate frames stored in the static grant queue 309 to transfer to the start time calculator 314, and then reads gate frames stored in the dynamic grant queue 310 to transfer to the start time calculator 310 prior to reading data frames from the PON bridge. Thereby, a fixed-length grant set as an arbitrary short length is distributed to all ONUs per grant allocation cycle. Then with the remaining time resources, a dynamic grant is distributed to each ONU. Therefore, at least one report frame can be received from all ONUs per grant allocation cycle. Based on such report frame received, grants can be equitably allocated with respect to requests by each ONU.

The start time calculator 314 receives a data to send from the transmit multiplexer 311 to transfer to the PON. If a data to send is an MPCP frame, a timer value of the OLT 110 is inserted. And if the data is a gate frame of the MPCP frame, a transmission start time is determined for the grant value for insertion. The transmission start time is determined in such a way that the allocated grant periods expressed by the start tie and length for the ONUs (LLID) 120a-120c do not overlap with each other when the RTT is not considered. At the same time, each transmission start time is set at future by a predetermined value (minimum offset) from the present time and before transmission, an amount equivalent to the Round Trip Time (RTT) of the ONU is subtracted to compensate for transmission latency caused by distance difference.

The OLT 110 sends a timer value thereof on all MPCP frames transferred to the ONUs 120a-120c. The ONUs 120a-120c then duplicate the received timer value of the OLT 110 into a timer thereof upon receiving the MPCP frame from the OLT 110 to synchronize its timer with the timer of the OLT 110. Moreover, the ONUs 120a-120c send the timer value thereof to all MPCP frame transferred to the OLT 110. The OLT 110 then figures out the differences between the timer value loaded on the MPCP frame of the ONUs 120a-120c and the timer value of itself to calculate the RTT value of the ONUs 120a-120c which includes transmission latency and propagation delay on the optical fiber. After the start time calculator 314 determines the start time of the grant for the ONUs (LLID) 120a-120c, it subtracts the RTT value of the ONU just before transmitting the gate frame to the ONU, to compensate for transmission latency. Therefore, the ONUs located farther can send data earlier according to the compensated grant start time, so that upstream frames sent from the ONUs located in different distances do not overlapped when arriving at the OLT 110.

Further, since the RTT value of the ONU is subtracted from the start time before transmission, to make a sufficiently future start time value to be sent down even after subtracting the RTT value from the start time, the start time of grant should is maintained at future by the minimum offset(maximum RTT+minimum waiting time at ONT specified by the standard) before subtracting RTT. This is to ensure that at least a guaranteed time set by the standard remains until the start time when the ONUs 120a-120c receive the gate frame.

The start time calculator 314 sends the grant (start time and length) with the value before subtracting the RTT value to the receiving window generator 315 to generate a window signal fitting a burst input.

Alternately, the receiving window generator 315 uses information sent by the start time calculator 314 to generate a window signal corresponding to an anticipatory burst input length. In other words, in accordance with the grant information sent to the ONUs 120a-120c, it calculates the anticipatory arrival time of the upstream frame to be sent by each ONU, compensates for latency from an optical receiver to a timer extractor and provides the derived burst input window signal to the upstream optical receiver of the OLT 110. The window signal is provided to generate the reset signal for some types of the burst mode optical receivers which require a reset signal just before the burst input. If that kind of burst mode optical receiver is not used, the receiving window generator can be omitted.

The receiving demultiplexer 312 inspects a received upstream frame to transfer to a proper destination. General data out of the received frame is transferred to the PON bridge 210 and MPCP frames are processed according to the type of the frame. More particularly, out of the MPCP frames, the frames for requesting registration for ONU and acknowledgment, register_req and register_ack are transferred to a receiving CPU message queue 308 to be sent to a CPU and a report frame is transferred to the report writer 313. In addition, in all the MPCP frames received, a timer value of the ONUs 120a-120c is extracted, an RTT value is calculated by subtracting the extracted ONU timer value from the OLT's timer value, and the RTT information of the ONU (LLID) in the RTT table 306 is updated.

The above-defined EPON master apparatus can adopt allocation of the fixed bandwidth and the dynamic bandwidth simultaneously or selectively. The substantial elements relating to allocation of the dynamic bandwidth of the invention include the static grant generator 303, the report table 304, the dynamic grant generator 305, the RTT table 306, the dynamic grant queue 310, the transmit multiplexer 310, the receiving demultiplexer 312, the report writer and the start time calculator 314.

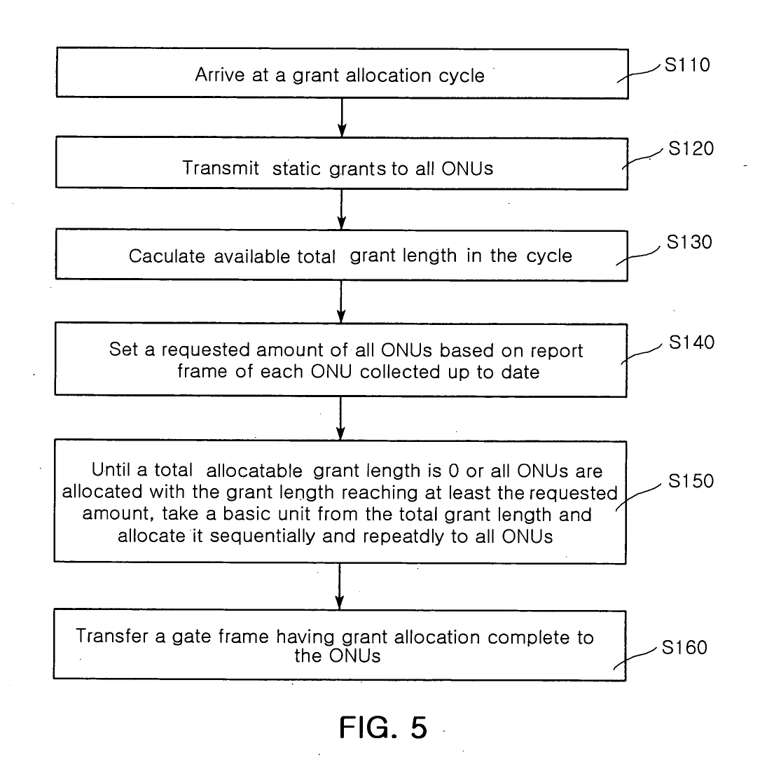

FIG. 4 shows a configuration of the dynamic grant generator 305, the apparatus for allocating a dynamic bandwidth of the invention.

FIG. 4 illustrates an example of a detailed configuration of an apparatus for allocating a dynamic bandwidth of the invention. As shown in FIG. 4, a report reading signal and deleting signal are connected to a report table 304 of FIG. 3. A cycle signal for grant allocation (DBA cycle start signal) and a total allocatable grant length in the cycle can be inputted from a static grant generator 303 and a dynamic gate frame generated is sent to the dynamic grant queue 310.

In the apparatus for allocating a dynamic bandwidth of the invention, although there is no limit in the number of ONUs (LLID) or processing cycle, it is assumed hereunder for convenience that a dynamic bandwidth is allocated in a cycle of 1.024 ms and 64 ONUs are processed.

As shown in FIG. 4, the apparatus for allocating a dynamic bandwidth of the invention, includes a report reader 401, a controller 402, bandwidth-allocating engines 403 and a frame generator 404.

The report reader 401 is inputted with a cycle signal for grant allocation (DBA cycle start signal) with a predetermined cycle (a cycle for allocating a grant length, 1.024ms in this embodiment), reads the latest report of the ONU, sets the effective requested amount of the grant for each ONU to satisfy the reported requested amount by claming it at the maximum permitted amount of grant while setting the minimum guarantee amount for each ONU at the same time, notifies the engines 403 of the same and notifies a controller 402 that a preparation for calculation has been made. In this case, report information of the ONU is read from the report table 304 of FIG. 3. Each entry of the report table has a record of the pre-set maximum grant length and minimum guarantee grant length along with a received report value. The report reader 401 has reading and deleting authority on the report table, thereby deleting the read report information after reading the report information, the maximum grant length and the minimum guarantee grant length writen by the CPU in a report table 304 and thus preventing the same report data from being re-used in a next cycle.

The controller 402, if the report reader 401 delivers the effective requirement amount and the minimum guarantee grant length to each bandwidth-allocating engine 403 and notifies that a preparation for allocation has been made, instructs the bandwidth-allocating engines 403 to allocate a grant, monitor processing of each engine 403, provides information necessary for operation of the engines 403 and controls an allocation process.

The plurality of bandwidth-allocating engines 403 are in charge of allocating the grant for at least an ONU, operating in parallel. For example, if 64 ONUs are registered in an EPON, the 4 bandwidth-allocating engines 403 allocate grant lengths to 16 ONUs, respectively. More specifically, if there are ONUs 1 to 64 and the 4 engines 403 are in charge of 16 ONUS, respectively, the 4 engines 403 are in charge of ONUs 1,5,9, . . . and 61, ONUS 2,6,10, . . . and 62, ONUs 3,7,11, . . . and 63, and ONUs 4,8,12, . . . and 64, respectively. At this time, grant allocation for the ONUs set in the bandwidth-allocating engines 403 is carried out sequentially. That is, the grant allocation starts from the first ONU up to the last ONU sequentially by basic unit, and then goes back to the first ONU. In this fashion, the allocation by basic unit is repeated.

More particularly, the bandwidth-allocating engines 403 are provided with the minimum guarantee amount and the effective requested amount of the ONU by the report reader 401, subtract a unit grant length from the total usable grant length in response to a start instruction from the controller 402 to repeatedly allocate the same to the corresponding ONU until the minimum guarantee amount or the effective requested amount of the ONU are satisfied or the total remaining usable grant length (common time resources available) becomes 0.

Further, the bandwidth allocation engines 403 categorize the effective requested amount set for each ONU into a high-priority effective requested amount and a low-priority effective requested amount. The engines 403 process the high-priority effective requested amount earlier than the low-priority effective requested amount, ensuring the high-priority data to be guaranteed its transfer first. Even though the grant are assigned in high priority and low priority order, merged grant values are transported in the same gate frame for each ONU.

The controller 402 provides the bandwidth-allocating engines 403 with the remainder of the total usable grant and operation conditions of another engine for allocating bandwidth 403, and carries out a control to ensure that the bandwidth-allocating engines 403 operate in parallel and in the same pace.

Further, the controller 402 collects time resources being allocated every instant, transferred from the bandwidth-allocating engines 403, and combines the information on whether or not the minimum guarantee amount or the effective requirement amount have been satisfied for each engine's ONU group. Then the controller 402 notifies the bandwidth-allocating engines 403 of whether or not there are any available remaining common time resources, there are any ONUs for which the minimum guarantee amount have not been met or there are any ONUs for which the effective requested amount have not been met. Also, the controller 402 notifies the engines 403 of whether or not there are any ONUs for which the high-priority effective requested amount or the low-priority effective requested amount have not been met in case where the priority information of the ONUs report are used.

Through the repetitive grant allocations of the engines 403, the total usable grant diminishes and in the end all requirements are satisfied or the remainder becomes 0. In this case, due to differences in the minimum guarantee amount and the effective requirement amount, the time to reach the grant amount required to satisfy the the ONUs' reuqests may vary for each ONU.

The bandwidth-allocating engines 403, if the grant allocation amount of the ONU reaches the effective requested amount or the total usable grant amount becomes 0, notify the frame generator 404 of the grant amount allocated to each ONU. A controller 402 checks the operation status of the engines 403, and if grant allocation for all ONUs is completed or the total usable grant becomes 0, instructs the frame generator 404 to generate the gate frames. Alternately, the frame generator 404 is provided with a grant length value allocated for each ONU, generates the gate frames including only the grant length but excluding the start time of grant, and outputs the same, which is stored in the dynamic grant queue 310 of FIG. 3 until transmitted to EPON.

The OLT 110 sends a fixed-length grant having a short length to all the ONUs 120a-120c per grant allocation cycle so that it can receive at least one report per cycle on all ONUs 120a-120c. Thereafter, a dynamic bandwidth is allocated so that remaining time resources, after allocation of the static grant in corresponding cycle, are allocated proportional to the requested amount (data amount to send) of each ONU 120a-120c based on reports collected. In addition, in case of allocating the dynamic bandwidth, requests of each ONU are prioritized as the report contains reports for each priority queue in the ONUs. And, when priority operation is enabled, the dynamic bandwidth is allocated first to a high-priority requested amount and then a low-priority requested amount. This guarantees QoS for data which needs real-time processing. This bandwidth allocation process will be explained in greater detail in reference to flow charts below.

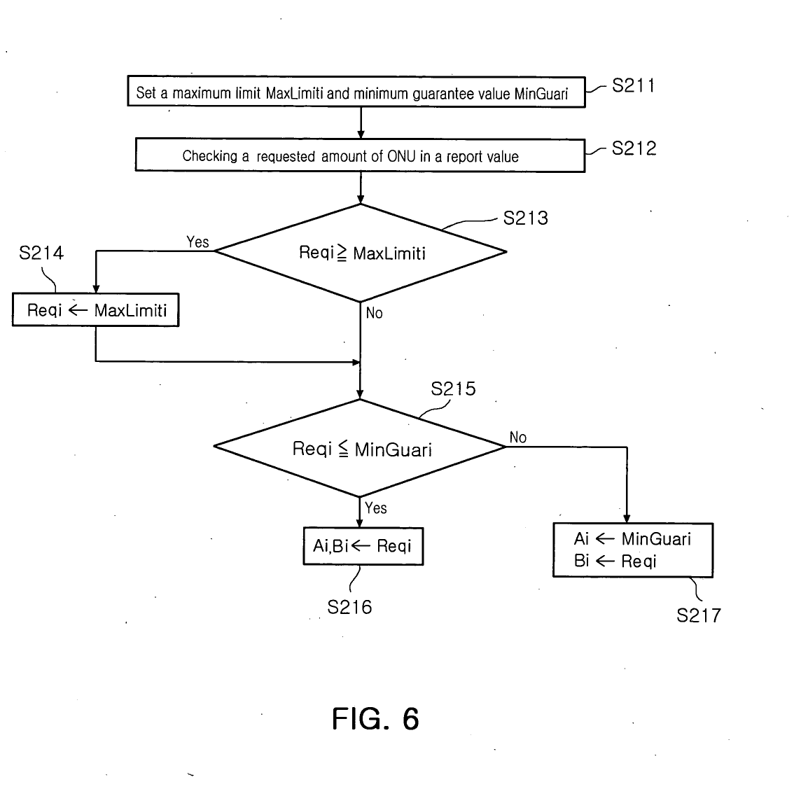

FIG. 5 is a flowchart showing an entire process of a method for allocating a dynamic bandwidth of the invention.

Referring to FIG. 5, allocation of a dynamic bandwidth of the invention is made every predetermined cycle. When a grant allocation cycle is started in S110 as specified by the CPU, a fixed-length grant having a short length is allocated to a gate frame to be transmitted to all ONUs in S120. The fixed-length grant is set to receive at least one report frame per grant allocation cycle and has as short a value as possible. But if we want to give static bandwidth to certain ONUs, the static grant can have certain long values.

Thereafter, a total grant length L usable in case of allocating the dynamic bandwidth in corresponding cycle is checked in S130. The total grant length is set to the remaining value obtained by subtracting from the total time resources available in the predetermined period the amount of static grants allocated by the static grant generator 303 and the amount of grants allocated by an outside CPU, which process is provided by the static grant generator 303.

Based on a received report frame from all registered ONUs 120a-120c, a requested amount of grant length necessary to transmit the upstream frames is set for each ONU in S140. The report value is provided via a report writer 313 and a report table 304 of FIG. 3.

Then, until the total allocatable grant length becomes 0 or the grant lengths allocated to all ONUs reaches the requested amount of the grant lengths set for each ONU, a basic unit is taken from the total grant length and distribution is made to each ONU sequentially and repeatedly in S150. The distribution of the grant length is carried out for all ONUs sequentially and repeatedly. By incrementing the grant length of an ONU by a basic unit and then incrementing the grant length of a next ONU by a basic unit, all ONUs have equal distribution chances for the grant length.

Through repetitive processes of the step 150, if the total remaining allocatable grant length becomes 0 or the grant lengths allocated to all ONUs reache the requested value set for each ONU, the allocated grant lengths of each ONU is set as the final allocation value of the grant length of the ONU to transmit in a gate frame in S160.

In setting a required grant amount for each ONU in S140, a minimum guarantee amount for each ONU and an effective requested amount corresponding to transmission data amount for each ONU are set. Also, the effective requested amount may be broken down into a high-priority effective requested amount related to a high-priority transmission data and a low-priority effective requested amount related to a low-priority transmission data.

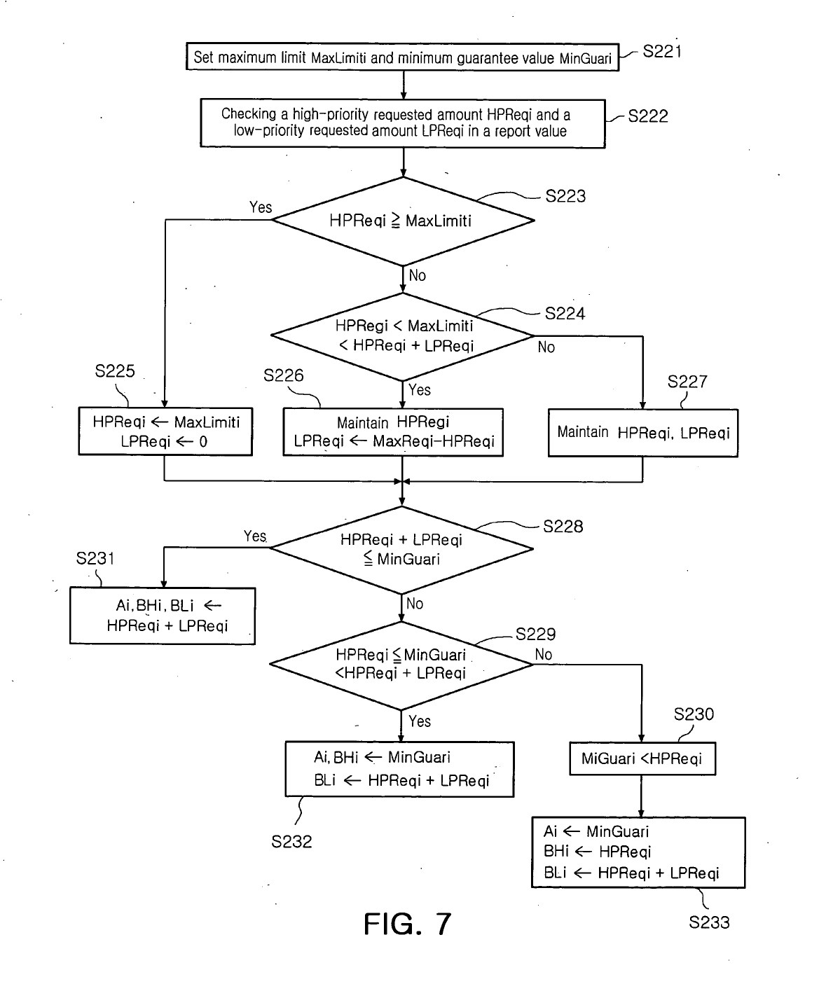

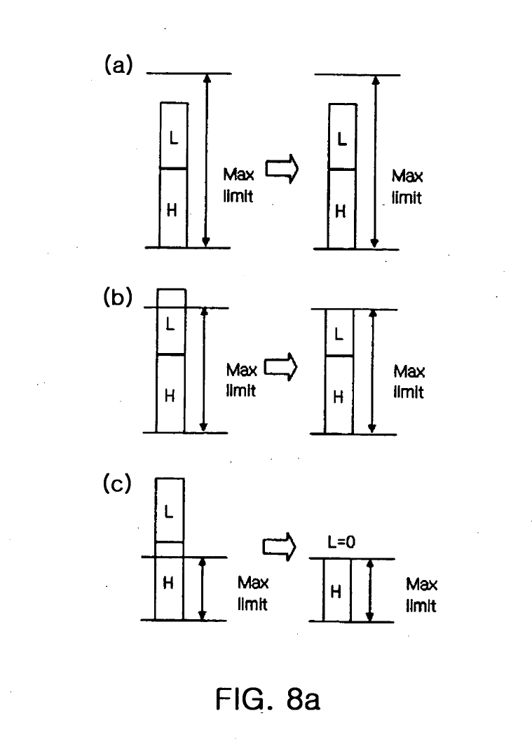

FIGS. 6 and 7 are flowcharts showing first and second embodiments of a process of setting the requested amount according to the invention.

Referring to FIG. 6, before setting the requested amount for each ONU, a maximum limit MaxLimiti of grant and a minimum guarantee value MinGuari are set in S211. The max limit MaxLimiti and minimum guarantee value MinGuari can be set arbitrarily for each ONU by an operator.

Then, report frames transferred from each ONU are read in to identify an actual requested amount Reqi of the ONU. The actual requested amount Reqi is the value sent from the ONU by measuring data amount to send which is stored in its sending queue at the time of sending report frame. Thus, the actual requested amount Reqi is an actual upstream bandwidth necessary for the ONU to send data.

After reading in the actual requested amount Reqi of corresponding ONU as described above, it is checked whether or not the actual requested amount Reqi is larger than the maximum limit MaxLimit in S213. If the requested amount Reqi of the ONU is larger than the max limit MaxLimiti, the requested amount Reqi of the ONU is changed into the maximum limit MaxLimiti in S 214. This restricts the upstream bandwidth allocated to the ONU to a maximum value, thus preventing excessive allocation to a specified ONU.

Thereafter, it is checked whether or not the modified requested amount Reqi of the ONU is less than the minimum guarantee value MinGuari in S215. If the requested amount Reqi is less than or equal to the minimum guarantee value MinGuari, the minimum guarantee amount Ai and the requested amount Bi of corresponding ONU is set as the requested amount Reqi. In contrast, if the actual requested amount Reqi is greater than the minimum guarantee value MinGuari, the minimum guarantee amount Ai of corresponding ONU is set as the minimum guarantee value MinGuari and the effective requested amount Bi is set as the actual requested amount Reqi.

As described above, each requested amount can be satisfied equitably for all ONUs by restricting to the maximum and satisfying the minimum guarantee amount (Ai) first during the water-filling bandwidth allocation operation.

FIG. 7 is a flowchart showing the process of setting a minimum guarantee amount Ai, a effective requested amount up to high-priority BHi and a effective requested amount up to low-priority BLi for water-filling in case the request from each ONU contains separate information on the priority data queues according to a second embodiment of the invention.

Referring to FIG. 7, as in the first embodiment, a maximum limit MaxLimiti and a minimum guarantee value MinGuari are set in S221 for each ONU. The maximum grant amount allocated to the ONU is set by the maximum limit MaxLimiti, and a minimum guaranteed grant amount is allocated according to the minimum guarantee value MinGuari. Then a high-priority requested amount HPReqi and low-priority requested amount LPReqi are checked based on report values received from each ONU in S222.

In general, a report frame can indicate a requested amount for up to 8 queues. In accordance with a programmable mapping, the requested amount for each priority requests for 8 priority queues are categorized into a high-priority requested amount corresponding to high-priority transmission data amount and a low-priority requested amount corresponding to low-priority transmission data amount. These correspond to the high-priority requested amount HPReqi and low-priority requested amount LPReqi in S222.

Then the high-priority requested amount HPReqi, and a sum of the high-priority requested amount HPReqi and low-priority requested amount LPReqi are compared with the set maximum limit MaxLimit in S223, S224.

After comparison, if the high-priority requested amount HPReqi is larger than the maximum limit MaxLimit, the high-priority requested amount HPReqi is changed into the maximum limit and the low-priority requested amount LPRei is changed into 0 in S225. In contrast, if the maximum limit MaxLimit is greater than the high-priority requested amount but smaller than the sum of the high-priority and low-priority requested amounts, the high-priority requested amount HPReqi is maintained as is and the low-priority requested amount LPReqi is changed into a value obtained by subtracting from the maximum limit MaxLimit the high-priority requested amount LPReqi, thus ensuring corresponding ONU does not exceed the maximum limit in S226. Then, if the maximum limit MaxLimit is greater than the sum of the high-and low-priority requested amounts, the high and low requested amount are maintained as they are because total requested amount of corresponding ONU does not exceed the maximum limit in S227.

The water-filling satisfies the request first for minimum guaranteed request, and then the sum of minimum guaranteed and high priority requests and finally the sum of minimum guaranteed and high and low priority requests while accumulating the grant length. So it is needed to set the cumulative threshold values. Thereafter, the high-priority requested amount HPReqi adjusted as above and the sum of the adjusted high- and low-priority requested amounts HPReqi and LPReqi are compared with the minimum guarantee value MinGuari in S228, S229 to set the cumulative thresholds.

After comparison, if the sum of the high-priority requested amount HPReqi and low-priority requested amount LPReqi is less than or equal to the minimum guarantee value MinGuari, the minimum guarantee amount Ai and the effective cumulative requested amount up to high priority BHi and effective cumulative requested amount up to low-priority BLi are all set as the sum of the high-priority requested amount HPReqi and the low-priority requested amount LPReqi in S231.

In contrast, if the minimum guarantee value MinGuari is larger than or equal to high-priority requested amount HPReqi but is smaller than the sum of the high- and low-priority requested amounts HPReqi and LPReqi, the minimum guarantee amount Ai and the effective cumulative requested amount up to high-priority BHi are set as the minimum guarantee value MinGuari. And the effective cumulative requested amount up to low-priority is set as the sum of the high- and low-priority requested amounts HPReqi and LPReqi in S232. Finally, if the minimum guarantee value is smaller than the high-priority requested amount HPReqi, the minimum guarantee amount Ai is set as the minimum guarantee value MinGuari and the effective cumulative requested amount up to high-priority BHi is set as the high-priority requested amount HPReqi and the effective cumulative requested amount up to low-priority BLi is set as the sum of high-priority requested amount HPReqi and low-priority requested amount LPReqi.

As stated above, by limiting the upper threshold at the maximum before the water-filling and satisfying for all ONUs in the order of minimum guarantee requested amount Ai, the cumulative threshold of sum of minimum guarantee requested amount Ai and high priority requested amount BHi, the cumulative threshold of sum of minimum guarantee requested amount Ai and high priority requested amount BHi and low priority requested amount BLi during the water-filling, maximum limiting and minimum guaranteeing, and priority based bandwidth assignment is possible.

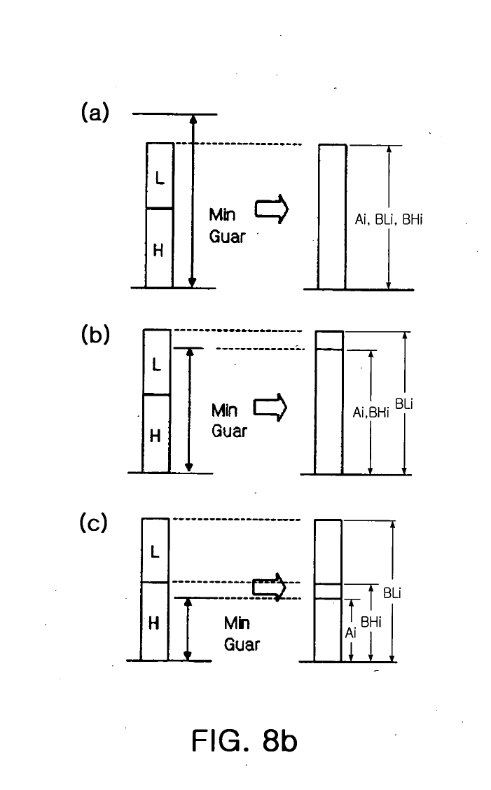

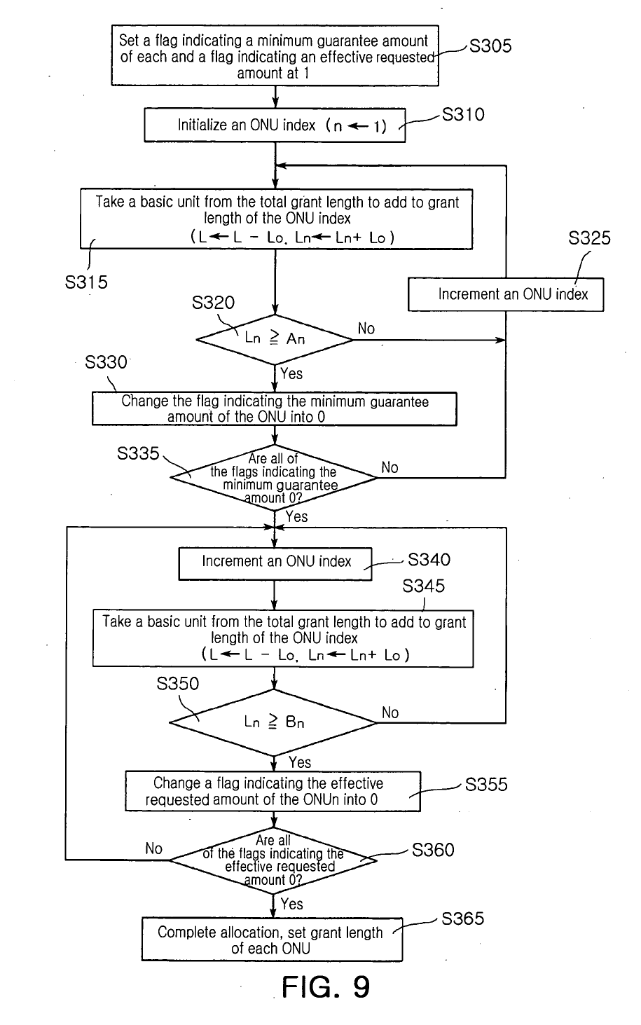

FIG. 8a is an example of limiting an upper threshold of the requested amount through a process in FIG. 7, and FIG. 8b is an example of setting a minimum guarantee amount, the effective cumulative requested amount up to high-priority, the effective cumulative requested amount up to low-priority through a process in FIG. 8b and FIG. 7.

That is, a high-priority requested amount H and a low-priority requested amount L requested actually by the ONU are set. Also, a maximum limit MaxLimiti and a minimum guarantee value minGuari are determined regardless of priority of each ONU. In this case, if as in FIG. 8a (a), the sum of the high-priority requested amount H and a low-priority requested amount L is smaller than the maximum limit, the high- and low-priority requested amounts are maintained as they are. Meanwhile as in (b), if the sum of the high-and low-priority requested amount H, L is greater than the maximum limit, the low-priority requested amount L is reduced so that the sum is the maximum limit. If, as in (c), the high-priority requested amount H is larger than the maximum limit MaxLimit, the high-priority requested amount H is reduced to the maximum limit MaxLimit and the low-priority requested amount L is 0.

After the upper threshold of the requested amount of each ONU is limited as mentioned above, the high and low priority request value is again divided further for water-filling processing into the effective minimum guarantee amount Ai, the effective cumulative requested amount up to high-priority BHi and the effective cumulative requested amount up to low-priority BLi as in FIG. 8b. That is, as in (a), if the minimum guarantee value MinGuar is greater than the sum of the high-and low-priority requested amounts H, L, the minimum guarantee amount Ai, the effective cumulative requested amounts up to high- and low-priority BHi and BLi are all set as the sum of the high-and low-priority requested amount H and L. Also, as in (b), if the minimum guarantee value MinGuar is greater than the high-priority requested amount H and less than the sum of the high-priority requested amount H and the low-priority requested amount L, both the minimum guarantee amount (Ai) and the effective cumulative request amount up to high-priority value BHi are set to the minimum guarantee value MinGuar and the effective cumulative requested amount up to low-priority BLi is set to the the sum of the high and low priority requested amounts H and L. In addition, if the minimum guarantee value MinGuar is smaller than the high-priority requested amount H as in (c), the minimum guarantee amount Ai is set to the minimum guarantee value MinGuar. The effective cumulative requested amount up to high-priority BHi is set to the high-priority effective amount H and the effective cumulative requested amount up to low-priority BLi is set to the sum of high and low priority requested amount.

Accordingly, the requested amount of each ONU can be set so that the maximum limit for each ONU is satisfied, and the minimum guarantee amount, the sum of minimum guaranteed and the the high-priority requested amount, and the sum of the high-priority and low-priority requested amount are satisfied in sequence to the greatest extent.

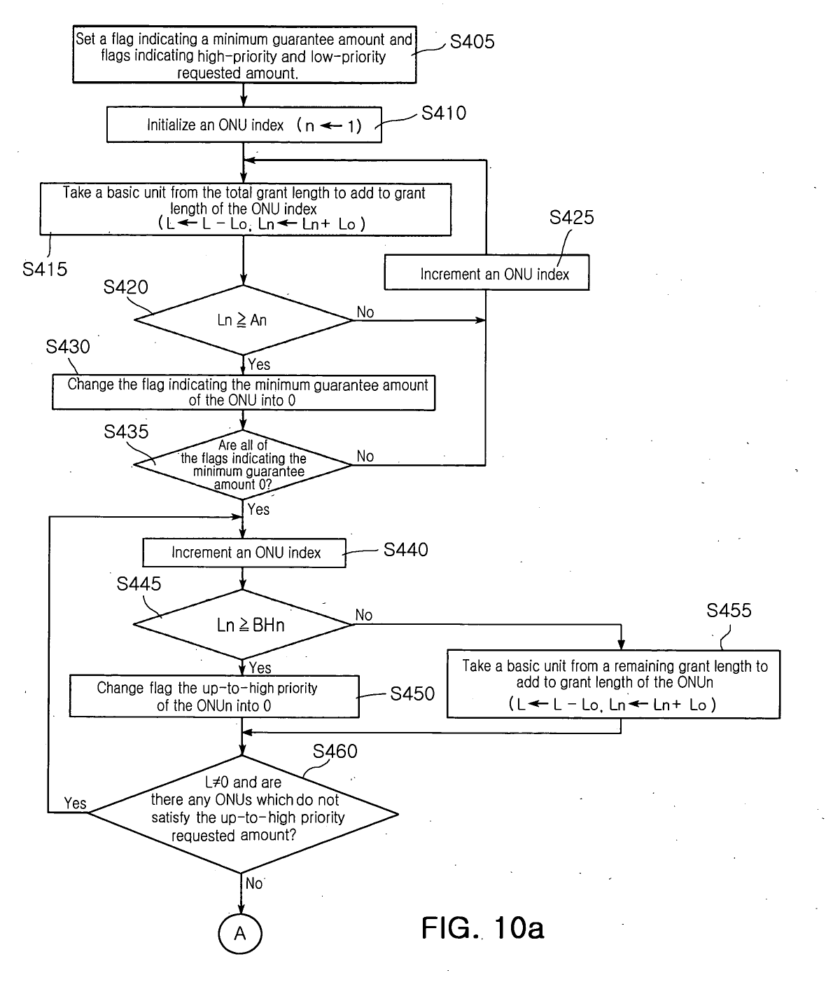

FIG. 9 illustrates details of the distributing step (S150) according to one embodiment of the invention, which may also be applied to the bandwidth-allocating engines 403 of FIG. 4.

FIG. 9 explains the distributing step (S300) in greater detail. To allocate a dynamic bandwidth, each engine 403 sets the flag indicating the processing status for the minimum guarantee amount and the flag indicating the processing status for the effective requested amount for each ONU to 1 in S305. The flag value 1 indicates that bandwidth assigned to the ONU designated by corresponding flag has not satisfied a minimum guarantee amount or an effective requested amount. Furthermore, the flag value is read by the controller 402 and used as information to identify the completion conditions of each engine 403. For each engine, when checking the flags for the completion, combined information for all other engines are used which is coming from the controller 402 so that the engines are in the process of satisfying the same type of requests (minimum guaranteed, effective requests).

The bandwidth-allocating engines 403 are capable of allocating grant for group of ONUs and thus an ONU index is initialized to indicate sequence of the grant allocation in S310.

Then, for the grant length of each ONU to reach the minimum guarantee amount of the ONU as set above, a basic unit is taken from the total grant length to be sequentially added to each ONU. The distributing step is described below.

A basic unit (Lₒ) is taken from the total grant length (L) calculated before the water-filling (L←L+Lₒ) so as to increase the grant length (L) of an ONUₙ identified by the ONU index by a basic unit (Ln←Ln+Lₒ) in S315. In other words, a basic unit is taken from the total grant length to allocate to the grant length for the ONU.

After the step (S315), it is checked whether or not the grant length (Lₙ) of the ONUₙ reaches at least the minimum guarantee amount of the ONU in S320. If the grant length is smaller than the minimum guarantee amount, the ONU index (n) is incremented to process the next ONU in S325 and the step (S310) is executed.

However, if the grant length (Lₙ) of the ONUₙ reaches at least the minimum guarantee amount, since the ONU (ONUₙ) does not need to increment the grant length for minimum guarantee amount any more, the flag indicating the minimum guarantee amount of the ONU is changed into 0 in S330.

By examining whether or not all flags indicating the minimum guarantee amount of the ONUs are 0, it is checked whether or not all ONUs have been allocated with the grant length equivalent to the minimum amount in S335. If any of the flags for the minimum guarantee amount completion is 1, since there remain the ONUs which have not been satisfied for the minimum guarantee amount, the step (S325) is executed.

If in the step S335, all the flags indicating the minimum guarantee amount completion are 0, this means that all ONUs are allocated with the grant length equivalent to the minimum guarantee amount,and the grant length is additionally distributed to satisfy the effective requested amount of the ONUs.

In a similar manner for the effective requested amount, to process the next ONU, an ONU index is incremented in S340, a basic unit is taken from the total grant length (L←L+Lₒand added to the length of the ONU (ONUₙ) (L←Lₙ+Lₒ), the grant length is allocated to an ONU by a basic unit in S345. Then, it is checked whether or not the grant length of the incremented ONU reached the effective requested amount of the ONU in S350. If the grant length (Lₙ) of the incremented ONU is smaller than the effective requested amount, the step (S340) is executed.

However, if in the step (S350), the grant length (Lₙ) of the ONU reached at least the effective requested amount, since the ONU (ONUₙ) do not need to be allocated with the grant length any more, a flag indicating the effective requested amount is changed to 0 to notify thereof in S355.

It is checked whether or not all flags indicating the effective requested amount are 0 or the total grant length are 0 in S360 to see if it is the point the grant allocation should be terminated. If all the flags indicating the effective requested amount are 0, since all ONUs have a grant length larger than the effective requested amount, there is no need to allocate the grant any more. Also, if the total grant length (L) is 0, since there remains no time resources available (grant length) for allocation, the grant cannot be allocated.

If in the step (S360), the total grant length is not 0 and any of the flags is 1, to allocate the grant lengths more, the step (S340) is executed incrementing an ONU index,

If through repetitive processes of the steps, the total remaining grant length is 0 or all the flags indicating the effective requested amount completion state are 0, grant allocation is terminated and an allocated length for each ONU is set as the final allocation value of grant length in S365. The grant length of the ONU as set above is provided to the frame generator 404 of FIG. 4 to sequentially generate a gate frame. The gate frame generated, which has only a grant length value but not the grant start time, is sequentially stored in the dynamic grant queue 310 of FIG. 3. The gate frame is then transmitted to the ONU via the transmit multiplexer 311, with transmission start time determined by the start time calculator 314 inserted therein just before being transmitted. Transmission start time is determined by the start time calculator 314 as set forth above.

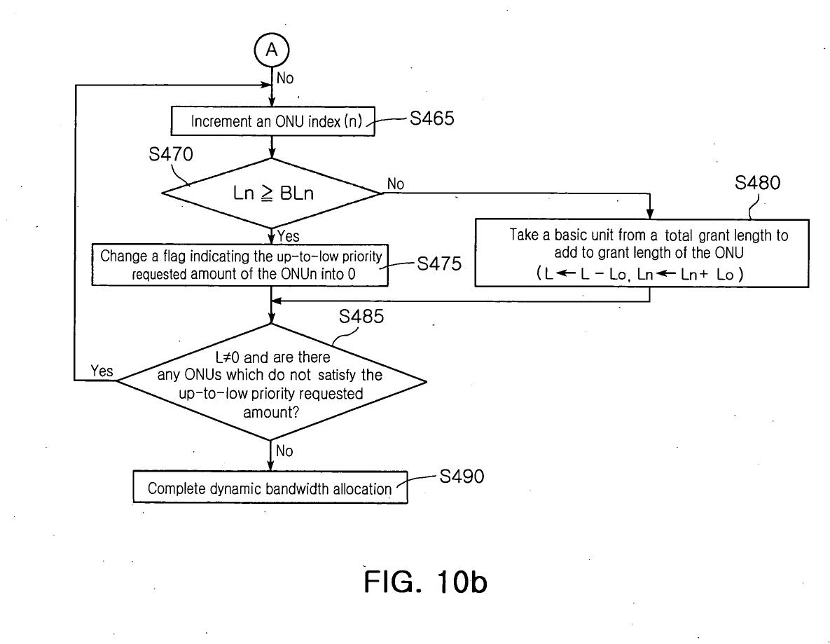

FIGS. 10a and 10b show a detailed flowchart of a distributing step S150 according to another embodiment of the invention, where the effective requested amount is prioritized. The process below can be applied to the bandwidth-allocating engines 403 shown in FIG. 4 as previously described.

Referring to FIGS. 10a and 10b, as in the embodiment described above, first the flags for minimum guarantee amount and the flags for cumulative requested amount for up to high priority and low priority are set as 1, respectively, in S405. At this time, the flag value 1 means that bandwidth assigned to the ONU designated by corresponding flag has not satisfied the minimum guarantee amount or the effective cumulative required amount up to high priority or low priority. The flag value is read by the controller 402 and used as data for identifying conditions of each engine 403. For each engine, when checking the flags for the completion, combined information for all other engines are used which is coming from the controller 402. so that the engines are in the process of satisfying the same type of requests (minimum guaranteed, cumulative requests up to high priority, cumulative requests up to low priority). Then the ONU index is initialized for processing the first ONU in sequence in S410.

Thereafter, the grants are allocated through following steps so that the minimum guarantee amount, effective cumulative requested amount up to high-priority, and effective cumulative requested amount up to low-priority for each ONU are satisfied.

That is, a first distribution process includes steps S415,S420,S425 while incrementing index of the ONU cyclically and repeatedly, taking a basic unit Lo from the total usable grant length L (L←L−Lₒ) to add to the grant length Ln of ONUₙ indicated by the ONU index (Lₙ←Lₙ+Lₒ), and judging whether or not the grant length of the ONUn has reached the minimum guarantee amount An. It is repeated until all the flags indicating the completion status for minimum guarantee amount is 0 in S430, S435.

If the grant lengths allocated to each ONU through the aforesaid process satisfy the minimum guarantee amount, in other words, if the flags indicating the minimum guarantee amount for all ONUs are 0, the effective high priority requested amount are processed.

That is, ONU index value is incremented cyclically and if the grant length of the ONU is less than the cumulative requested amount up to high-priority, the basic unit is taken from the total grant length (L←L−Lₒ) to be added to the grant length of corresponding ONU (Lₙ←Lₙ+Lₒ). Also, if the grant length of corresponding ONU has reached effective cumulative request amount up to the high-priority, the process of changing corresponding flag indicating the satisfaction for the effective request amount into 0 is repeated until the all the cumulative requested amount up to high-priority is satisfied or the available grant length L becomes 0 in S 440-460.

Through the aforesaid process, if the effective cumulative requested amount up to high-priority is satisfied, ONU index is incremented cyclically and grant is allocated until the effective cumulative requested amount up to low-priority is satisfied or the grant length becomes 0. That is, if the grant length of the ONU is less than the cumulative requested amount low up to low priority, a basic unit is taken from the total grant length to be added to the grant length of corresponding ONU. If the grant length of corresponding ONU reaches the cumulative requested amount up to low-priority flags indicating the satisfied state of the effective requested amount up to low priority are changed to 0. These process is repeated in steps 465-485.

Accordingly, if the minimum guarantee amount, high-priority requested amount, low-priority requested amount are satisfied sequentially or the remaining grant length L becomes 0, all grant lengths have been allocated during the grant allocation cycle. Then the gate frames for the ONUs having allocation completed is generated by the frame generator 404. The gate frame is transmitted to the ONU via the dynamic grant queue 310 and transmit multiplexer 311. The gate frame is transferred to the ONU with transmission start time inserted just before being transmitted by the time start calculator 314.

This allows equitable grant allocation to all ONUs and efficient differential service by allocating bandwidth first to high-priority requests.

The following is an example of the bandwidth allocation algorithm programmed to implement a second embodiment of the invention.
(Fixed Allocation Subtraction)

$$AV = AV - {\sum }_{i = 1}^{N} {FixedGateLength}_{i}$$

(CPU Reserved Length Subtraction)

$$AV = AV - {\sum }_{i = 1}^{M} {CpuGateLength}_{i} ( if any ) ;$$

(Adjustments for Maximum Limiting)
If (HighPriorReqᵢ>=MaxLimitᵢ)
HighPriorReqi=MaxLimiti LowPriorReqi=0;
Elsif (HighPriorReqᵢ<MaxLimitᵢ<HighPriorReqᵢ+LowPriorReqᵢ)
HighPriorReqᵢ=HighPriorReqᵢ LowPriorReqᵢ=MaxLimit−HighPriorReqᵢ
(Separation into 3 Target Variables)
If (HighPriorReqᵢ+LowPriorReqᵢ<=MinGuarᵢ)
Gᵢ=Hᵢ=Lᵢ=HighPriorReqᵢ+LowPriorReqᵢ;
Elsif (HighPriorReqᵢ<=MinGuari<HighPriorReqᵢ+LowPriorReqᵢ)
Gᵢ=Hᵢ=MinGuari, Lᵢ=HighPriorReqᵢ+LowPriorReqᵢᵢ
Elsif (MinGuarᵢ<HighPriorReqᵢ)
Gᵢ=MinGuarᵢ Hᵢ=HighPriorReqᵢ Lᵢ=HighPriorReqᵢ+LowPriorReqᵢ
(Water-Filling for Minimum Guaranteed Request)
While (not all Gᵢ satisfied) and (AV>UnitLength){
If Gᵢ not satisfied {Allocᵢ=Allocᵢ+UnitLength; AV=AV−UnitLength;}increment i;} /* now Gi is satisfied */
(Water-Filling for High Priority Request)
While (not all Hᵢ satisfied) and (AV>UnitLength){
If Hi not satisfied {Alloci=Alloci+UnitLength; AV=AV−UnitLength;}increment i;} /* now Hi is satisfied */
(Water-Filling for Low Priority Request)
While (not all Lᵢ satisfied) and (AV>UnitLength){
If Li not satisfied {Alloci=Alloci+UnitLength; AV=AV−UnitLength;}increment i;}/* now Li is satisfied */

In the algorithm above, AV is total time resources in corresponding cycle; MaxLimiti is the maximum limit of ONUi; MinGuari is a minimum guarantee value of ONUi; HighPriorReqi is a high priority requested amount of ONUi; LowPriorReqi is a low-priority requested amount of ONUi; UnitLength is a unit length for allocation; Gi, Hi, Li and Alloci are a minimum guarantee amount, effective cumulative requested amount up to high-priority, effective cumulative requested amount up to low-priority and allocated grant length, set respectively for the ONU.

In the above pseudo-code, the effective minimum guaranteed amount, effective high-priority requested amount, effective low priority requested amount values were separately set. The water filling operation has separate processing stages for minimum guaranteed, high priority and low priority requested amount. At each stage, we can have as much as the basic unit length as the over allocation amount. This over-allocation can accumulate at each stage and become a large value. To minimize this over-allocation error, we can set the Gi, Hi and Li in a cumulative way. That is, the new Gi is calculated as explained before, the new Hi is calculated as the sum of previous Gi and previous incremental Hi, the new Li is calculated as the sum of previous Gi, previous incremental Hi, and previous incremental Li. This gives the cumulative meaning to Gi, Hi, and Li and by processing for Gi, Hi, and Li at three stages, we don't have the over-allocation due to unit length assignment accumulate every stage. This holds true for case when we don't have the priority mechanism.

Allocation of the grant lengths as described above has advantages: the grants can be allocated fast without DSP or CPU by allocating the grant length in parallel using the engines within the limited common time resources available; excessive grant allocation can be prevented even in the case of congestion in which requests of all ONUs can not be accepted due to too much data to be sent by the ONUs; fairness is ensured; the maximum upstream bandwidth is limited for each ONU and at the same time the minimum guarantee bandwidth is guaranteed for each ONU.

As stated above, the present invention allows the OLT in the EPON having plurality of ONUs registered to collect reports regularly and allocate grant dynamically in a short time without DSP or CPU. Also, by subtracting a grant amount sent by the static grant and the CPU, and thus predetermining the sum of the available grant amount dynamically in advance, and by allocating the grant to the ONUs within the limit at the same time, excessive grant allocation can be prevented even if there are any excessive requests for upstream bandwidth. Accordingly, the grant can be controlled at a proper time and a stable operation can be ensured. Moreover, the maximum grant length is limited for each ONU, while the minimum bandwidth is guaranteed for each ONU, leading to effective control of the upstream bandwidth in the EPON.

While the present invention has been shown and described in connection with the preferred embodiments, it will be apparent to those skilled in the art that modifications and variations can be made without departing from the spirit and scope of the invention as defined by the appended claims.

What is claimed is:

1. A method of allocating dynamic bandwidth in an Ethernet Passive Optical Network (EPON) to allocate an upstream bandwidth through which a plurality of Optical Network Units (ONUs) send data to an OLT, the method adopting cyclic processing with predetermined cycle time and comprising steps of:
(a) calculating a total allocatable grant length in the cycle;
(b) setting a requested amount of grant lengths needed for each ONU that were received and stored in a table during the report frame reception;
(c) distributing sequentially and repeatedly a grant length to each ONU by taking a basic unit from the total grant length and adding it to the ONU's grant until the total remaining grant length becomes 0 or the allocated grant length reaches the requested amount of grant length for each ONU; and
(d) setting the allocated grant length for each ONU at the moment as the final grant length of the ONU for that cycle, if the total allocatable grant length becomes 0 or the allocated grant length reaches the requested amount of grant length set for each ONU.

2. The method according to claim 1, further comprising: allocating and delivering a fixed-length grant pre-set to each ONU at the beginning of the cycle so as to receive at least one report frame from each ONU per grant allocation cycle.

3. The method according to claim 2, wherein the total allocatable grant length is set as the remaining value obtained by subtracting from total time resources available at the given cycle the amount of the fixed-length grant distributed to each ONU and the amount of grant generated in the CPU.

4. The method according to claim 1, wherein a report frame of the ONUs used in the setting step (b) is cleared after being used to allocate the grant and not allowed to be re-used for the next cycle.

5. The method according to claim 1, wherein the setting step (b) comprises:
adjusting an actual requested amount of each ONU described in each of the report frames to be within a maximum limit pre-set for each ONU thus setting this adjusted requested amount as the effective requested amount of each ONU; and
setting a minimum guarantee amount as set by the CPU;

6. The method according to claim 5, wherein the actual requested amount comprises a high-priority requested amount and a low-priority requested amount, and the effective requested amount comprises a high-priority effective amount and a low-priority effective amount.

7. The method according to claim 5, the adjusting step comprises:
setting the maximum limit for each ONU;
setting the actual requested amount of each ONU from the report frames from each ONU;
comparing the actual requested amount with the maximum limit; and
if the actual requested amount is more than the maximum limit, changing the effective requested amount to the maximum limit, and if the actual requested amount is less than the maximum limit, maintaining the effective requested amount as the actual requested amount.

8. The method according to claim 5, wherein the setting step comprises:
comparing the actual requested amount with the minimum guarantee value; and
if the actual requested amount is less than the minimum guarantee value, setting the minimum guarantee amount and the effective requested amount of the ONU as the actual requested amount, but if the actual requested amount is larger than the minimum guarantee value, setting the minimum guarantee amount of the ONU as the minimum guarantee value set for the ONU, and setting the effective requested amount as the actual requested amount.

9. The method according to claim 6, wherein the adjusting step comprises:
setting the maximum limit for each ONU;
setting the high-priority requested amount and low-priority requested amount actually requested by the ONUs from the report frames of the ONUs;
comparing the set high-priority requested amount, the sum of the high-priority requested amount and low-priority requested amount, and the maximum limit; and
maintaining the high-priority requested amount as it is and changing the low-priority requested amount into a value obtained by subtracting from a sum of the high-priority requested amount and low-priority requested amount the maximum limit if the maximum limit is greater than the high-priority requested amount and smaller than a sum of the high-priority requested amount and low-priority requested amount, but changing the high-priority requested amount into the maximum limit and changing the low-priority requested amount into 0 if the maximum limit is smaller than the high-priority requested amount.

10. The method according to claim 6, wherein the setting step comprises:
comparing the high-priority requested amount and the sum of the high-priority requested amount and the low-priority requested amount with the minimum guarantee value;
setting the minimum guarantee amount and the effective cumulative requested amount up to high-priority and up to low-priority as the sum of the high-priority requested amount and low-priority if the minimum guarantee value is greater than the sum of the high-priority requested amount and low-priority requested amount requested amount;
setting both the minimum guarantee amount and the effective cumulative requested amount up to high-priority as the minimum guarantee value, and the effective cumulative requested amount up to low-priority as the sum of the high-priority requested amount and low-priority requested amount if the minimum guarantee value is greater than the high-priority requested amount and smaller than the sum of the high-priority requested amount and low-priority requested amount; and
setting the minimum guarantee amount as the minimum guarantee value, the effective cumulative requested amount up to high-priority as the high-priority requested amount, and the low-priority effective requested amount as the sum of high-priority requested amount and low-priority requested amount if the minimum guarantee value is smaller than the high-priority requested amount.

11. The method according to claim 5, wherein the distributing step comprises:
distributing sequentially and repeatedly a basic unit by taking it from the total grant length and adding it to each ONU until the grant length of each ONU reaches the minimum guarantee amount of each ONU; and then
distributing sequentially and repeatedly a basic unit by taking it from the total allocatable grant length and adding it to each ONU until the grant length of each ONU reaches the effective requested amount or the total remaining allocatable grant becomes 0.

12. The method according to claim 6, wherein the distributing step comprises:
(i) distributing sequentially and repeatedly a basic unit by taking it from the total grant length and adding it to each ONU until the grant length of each ONU reaches at least the minimum guarantee amount of each ONU;
(ii) distributing sequentially and repeatedly a basic unit by taking it from the total allocatable grant length and adding it to corresponding ones of the ONUs until all the effective cumulative requested amount up to high-priority is satisfied or the total allocatable grant length becomes 0, if the distributed grant length of all ONUs reaches at least the minimum guarantee amount in step (i); and
(iii) distributing sequentially and repeatedly a basic unit by taking it from the total allocatable grant length and adding it to corresponding ones of the ONUs until all the effective cumulative requested amount up to low-priority is satisfied or the total allocatable grant length becomes 0, if all the effective cumulative requested amounts up to high-priority have been satisfied in step (ii).

13. An apparatus for allocating a dynamic bandwidth in an EPON to allocate an Ethernet Passive Optical Network (EPON) an upstream bandwidth through which a plurality of ONUs send data to Optical Line Termination (OLT), the DBA (dynamic bandwidth allocation) being cycle based, where static gates are sent for all ONUs at the beginning of the predetermined cycle, and dynamic gates are sent using the remaining resources to all ONUs, comprising:
a report reader which is initiated by a start signal coming periodically with a predetermined cycle and sets a required grant amount for each ONU by reading report values that have been received and stored in a table up to that moment;
at least one bandwidth-allocating engine in charge of ONU groups, the engine being adapted to receive a required grant amount of the ONU in its group from the report reader, take a basic unit from the total usable grant length and additively allocate it each ONU in a sequential and repeated manner so that the grant length of the ONU reaches the required grant amount, and
a controller adapted to collect operation status of the report reader and a plurality of the bandwidth-allocating engine, control the start and stop of the engines, and notify the engines of the remaining amount of the total remaining grant length and combined status of the satisfaction of the required grant amount of all ONUs.

14. The apparatus according to claim 13, wherein the report reader is adapted to delete the report value which has been once used.

15. The apparatus according to claim 13, wherein the report reader is adapted to set the minimum guarantee amount as set by the CPU, and the effective requested amount as received from the report frame from each ONU.

16. The apparatus according to claim 15, wherein the effective requested amount of each ONU is prioritized into a high-priority effective requested amount and a low-priority effective requested amount.

17. The apparatus according to claim 15, wherein the controller is adapted to control the bandwidth-allocating engine so that the minimum guarantee amount of all ONUs is satisfied first and then the effective requested amount of each ONU is satisfied.

18. The apparatus according to claim 16, wherein the controller is adapted to control the bandwidth-allocating engine so that the grant length of each ONU satisfies the minimum guarantee amount first, and then effective cumulative requested amount up to high-priority, and then the effective cumulative requested amount up to low-priority sequentially.

19. An apparatus according to claim 15, further comprising a frame generator adapted to generate the gate frames for the ONUs after the allocation of the grant length is completed by the engines.

20. An Ethernet Passive Optical Network (EPON) master apparatus for processing Multi-point Control Protocol (MPCP) for data communication of an EPON including an OLT and a plurality of Optical Network Units (ONUs), the DBA (dynamic bandwidth allocation) being cycle based, where static gates are sent for all ONUs at the beginning of the predetermined cycle, and dynamic gates are sent using the remaining resources to all ONUS, comprising:
a report table storing report data sent from each ONU;
a dynamic grant generator adapted to set a required grant amount of each ONU based on report data of each ONU in the report table per grant allocation cycle, allocate a basic unit from a total usable grant length to each ONU sequentially and repeatedly, and if the total remaining usable grant length becomes 0 or the grant lengths allocated to all ONUs reache at least the required grant amount at a time point, set the dynamic grant value as the final grant value based on the amount distributed to each ONU at the time point;
a dynamic grant queue storing the dynamic grant frames generated by the dynamic grant generator;
a transmit multiplexer adapted to multiplex downstream frames coming from the network port and the gate frames from the dynamic grant queue;
a receiving demultiplexer adapted to demultiplex a received upstream frame to transfer to each destination, a report frame out of the received frames being transferred to a report writer;
a report writer adapted to update the report data of each ONU in the report table in accordance with the report frame contents transferred from the receiving demultiplexer; and
a start time calculator adapted to determine transmission start time to be at future by a predetermined offset value from the present time and insert the grant start time to the gate frame out of downstream data transmitted from the transmit multiplexer while ensuring adjacent grant lengths not to overlap with each other.

21. The apparatus according to claim 20, further comprising:
a static grant table storing information on fixed length grant for each ONU;
a static grant generator adapted to read the static grant table information per grant allocation cycle, allocate the static grant length to each ONU, and notify the dynamic grant generator of an usable grant length per grant allocation cycle excluding the allocated static grant length; and
a static grant queue storing the static grant value generated by the dynamic grant generator.

22. The apparatus according to claim 20, further comprising an RTT table storing RTT value for each ONU calculated based on timer value of each ONU obtained from received MPCP frames,
wherein the start time calculator is adapted to subtract RTT of a corresponding ONU from the set transmission start time of the grant in order to compensate transmission latency caused by distance difference.

23. The apparatus according to claim 20, wherein the dynamic grant generator has reading and deleting authority on the report table, thereby deleting the read report value just after reading it.

24. The apparatus according to claim 20, wherein the dynamic grant generator comprises:
a report reader adapted to receive a periodic start signal which is coming with a predetermined cycle and set the required grant amount for each ONU based on report value of the ONUs;
at least one bandwidth-allocating engine in charge of ONU groups, the engine being adapted to receive the required grant amount of the ONU from the report reader and take a basic unit from the total usable grant length and allocate it to the grant length of the ONU sequentially and repeatedly so that the grant length of the ONU reaches the required grant amount;
a controller adapted to collect operation status of the report reader and bandwidth-allocating engines, control start and stop of the engines, and provide the engines with the remaining amount of the total grant length and combined form of satisfaction status of the required grant amount of the ONUs; and
a frame generator adapted to generate gate frames sequentially for the ONUs, to which dynamic grant frames are to be sent, based on the grant value obtained from the engines in response to the instruction from the controller.

25. The apparatus according to claim 24, wherein the report reader sets the required grant amount, a minimum guarantee amount and an effective requested amount in proportion to data to be sent by each ONU.

26. The apparatus according to claim 25, wherein the effective requested amount of each ONU is prioritized into effective high-priority requested amount and effective low-priority requested amount.

27. The apparatus according to claim 25, where the controller is adapted to control the bandwidth-allocating engine so that the minimum guarantee amount of all ONUs is satisfied first and then the effective requested amount of each ONU is satisfied.

28. The apparatus according to 27, wherein the controller is adapted to control the bandwidth-allocating engine so that the grant length of each ONU satisfies the minimum guarantee amount first, and then the effective cumulative requested amount up to high-priority and the effective cumulative requested amount up to low-priority sequentially.
